(19) United States
(12) Patent Application Publication
(10) Pub. No.: US 2009/0066142 A1
(43) Pub. Date: Mar. 12, 2009

(54) Automobile Vehicle Passenger Seat and Process For Producing A Vehicle Passenger Seat

(76) Inventors: Kevin J. Ventura, Aschaffenburg (DE); Mari C. Milosic, Grosse Pointe Park, MI (US)

Correspondence Address: MAGNA INTERNATIONAL, INC., 337 MAGNA DRIVE, AURORA, ON, L4G-7K1, CA

(21) Appl. No.: 11/909,994

(22) PCT Filed: Mar. 8, 2006
(86) PCT No.: PCT/EP2006/002129

§ 371 Date: May 28, 2008

Related U.S. Application Data
(60) Provisional application No. 60/666,490, filed on Mar. 30, 2005.

(51) Int. Cl. B60N 2/44; B32B 27/32; B29C 44/04; A47C 7/26; B60N 2/58; B60N 2/015

(52) U.S. Cl. 297/452.26; 428/219; 264/45.1; 297/452.48

(57) ABSTRACT

The present invention relates to an automobile vehicle passenger seat which comprises a seat body (10) molded from EPP-foam, said EPP-foam having an average density of between 30 and 60 g/l, vehicle anchorage means (21) connected to said seat body for anchoring said seat to the automobile vehicle, and a trim cover (30). Furthermore, the present invention refers to an appropriate upholstery for use in an automobile vehicle and a process for producing such an upholstery.

### FIELD OF THE INVENTION

The present invention relates to an upholstery, pareticlarly to an upholstery for a seat, particularly for use in vehicles. More specifically, the present invention relates to a novel passenger seat for vehicles which obviates the need for a pan or a wire frame structure. The present invention also relates to a process for producing an upholstery, particularly an upholstery for a passenger seat for use in vehicles.

### DESCRIPTION OF THE RELATED ART

Passenger seats in vehicles such as automobiles are typically fabricated from a foam, usually polyurethane material which is molded into the desired shape and covered with an appropriate trim cover. The foamed material is selected to provide passenger comfort by providing a resilient seat and the trim cover is selected to provide the desired aesthetic properties.

To meet desired safety standards, passenger seats in vehicles such as automobiles now often provide anti-submarine properties. Submarining is the term used to describe the tendency of the pelvis of a seated passenger to move forward and down during a collision. When the passenger is wearing a belt, usually a 3-point harness comprising an integrated lap and shoulder belt, this tendency can result in the seat belt strangling the passenger with fatal consequences. Accordingly, it is known in the art to design passenger seats with anti-submarine properties. These properties may be provided by rigid or semi-rigid members embedded in the seat and which provide additional pelvic support to the passenger during a collision. To function properly, these members can not move and thus, must be fixed directly or indirectly to the vehicle.

Normally the foamed material in the seat which provides passenger comfort does not simultaneously provide the necessary structural strength for the seat. This necessitates additional reinforcement of a seat to provide the degree of structural strength required to ensure proper mounting of the seat within the vehicle and proper support of anti-submarine elements. Accordingly, vehicular seats typically include a perimeter frame of metal which strengthens the seat. Further, support rails are typically mounted across the metal frame to stiffen the frame and to provide a suitable attachment point for the means used to anchor the seat to the vehicle. Conventionally, the metal frame and/or support rails are surrounded with the foam material when the seat is molded. There are many types of seat construction and rear limousine seats tend to differ from rear seats of a station wagon and both usually differ from front seats.

The requirement for such a perimeter metal frame and for support rails adds to the cost of manufacturing the seat and, more importantly, adds to the weight of a seat and the overall weight of the vehicle in which it is installed. The presence of metal frame and support rails or other components in the seat could probably hamper the eventual recycling of the seat material which is becoming increasingly important.

It is also known in the art that a passenger seat comprises a frame element molded from relatively high density, rigid foam, such as polyurethane foam, generally at a density of 35-60 g/l, vehicle anchorage means connected to the frame element, and a seat body comprising a resilient material, such as a polyurethane derived from a diphenylmethane diisocyanate-based system, fixed with respect to the frame element.

Polyurethane foams are conventional and use thereof in the automotive seating industry is well-known. Moreover, the polyurethane foam as used within the prior art is expensive at the required densities.

Therefore, it would be desirable to have a passenger seat, particularly a vehicle seat, which does not require the presence of a conventional metal frame or support rails and which has reduced weight, improved appearance and an enhanced manufacturability combined with reduced costs.

### SUMMARY OF THE INVENTION

It is an object of the present invention to provide a novel upholstery and a novel passenger seat formed by such an upholstery. It is another object of the present invention to provide a novel method of manufacturing an upholstery and an appropriate passenger seat.

Accordingly, in one of its aspects, the present invention provides an automobile vehicle passenger seat comprising a seat body molded from EPP-foam, the EPP-foam having an average density between 30 and 60 g/l; vehicle anchorage means connected to the seat body for anchoring the seat to the automobile vehicle; and a trim cover.

EPP-foam can be manufactured between 30-120 g/l, but a density between 30 and 60 g/l usually already guarantees an adequate stability.

In one possible embodiment of the passenger seat, the passenger seat further comprises at least one pelvic support element embedded in the seat body. It is possible that the pelvic support and the seat body are integrally molded as a unitary element.

In another possible embodiment of the present invention, the seat body of the passenger seat comprises a whole anti-submarine zone, the seat body and the anti-submarine zone are integrally molded as a unitary element. It is known in the art to design passenger seats with anti-submarine properties. These properties may be provided by rigid or semirigid members which provide additional pelvic support to the passenger during a collision. As is known by those skilled in the art, the pelvic support elements may be rigid hollow plastic or metal members. By providing a pelvic support element or even a whole anti-submarine zone which is integrally molded with the seat body as a unitary element, submarining of passengers can be easily reduced without need of additional elements which have to be placed accurately when molding the seat body. Therefore, costs and manufacturing time can be saved.

Moreover, in another embodiment of the passenger seat according to the present invention, the trim cover is attached to the seat body by means of suitable retainer engaging an undercut trench molded into the seat body. It is possible that the retainer is formed as an extruded plastic channel sew to the trim cover. There are further suitable mechanical retainers like hook and loop connection elements.

In still another embodiment of the passenger seat according to the present invention the vehicle anchorage means includes an anchor portion to engage a portion of the automobile vehicle and an attachment portion inmolded in the seat body. It is possible that the attachment portion inmolded in the seat body comprises two S-shaped arms each connected to a different end of the attachment portion.

Furthermore, it is possible that the seat body is appropriately modified with coring or trenches for local stiffness and weight reduction.

It is possible that the seat body is covered on its upper surface by a further foamed material which is softer than the EPP-foam used for the seat body in order to further enhance the comfort. Such a layer of foamed material would be placed between the trim cover and the seat body. It is also possible that such a soft layer is part of the trim cover. Such a compliant layer can be made of PU with a typical PU foam density between 42 and 50 g/l. This layer is usually significantly thinner than the seat body.

In another of the aspects of the present invention, the present invention provides an upholstery for use in an automobile vehicle, particularly for a passenger seat. The upholstery is composed of and molded from EPP-foam, the EPP-foam having an average density between 30 and 60 g/l.

In terms of the present invention, the upholstery has traits of a body material usable for any kind of cushion.

It is possible that the upholstery is formed as a seat body and connected with vehicle anchorage means for anchoring said seat body to the automobile vehicle.

The upholstery can also be formed as a head restraint or an armrest and connected with anchorage means for anchoring the head restraint or the armrest to a passenger seat.

In a further embodiment of the upholstery according to the present invention, an undercut trench is molded into the upholstery intended to be engaged by fasteners of a trim cover. The upholstery should be understood within the context of the present invention as an EPP sub-structure of any suitable cushion.

In another of its aspects, the present invention provides a process for producing an upholstery in a mold comprising a first mold half and a second mold half engageable to define a mold cavity, the process comprising the steps of:
inserting means for mechanical attachment to the vehicle, if necessary into at least one of the first mold and the second mold half;
dispensing a liquid foamable polypropylene in at least one of the first mold half and the second mold half;
closing the first mold half and the second mold half;
allowing the polypropylene to expand to fill substantially the mold cavity to produce a relatively low-density, stable upholstery.

It is possible that the process of the present invention further comprises the step of molding an undercut trench into the upholstery usable to attach a trim cover to the upholstery.

Possibly, the process of the present invention comprises the further step of applying a trim cover to the upholstery.

In a further embodiment of the process of the present invention, the upholstery is formed as a seat body for a passenger seat.

In another embodiment, the process of the present invention comprises the further step of integrally molding at least one pelvic support element with the seat body.

The use of expanded polypropylene (EPP) has several properties which are advantageous with respect to polyurethane or other foams usually used. EPP has a relatively light weight with simultaneous high tear and tensile strength. Furthermore, EPP has quite a good temperature stability from −40 to +110° C. EPP has good energy absorption characteristics and resiliency. Due to its closed cell structure, EPP has no or very low water absorption.

Moreover, EPP can be considered as nearly 100% recyclable and physiologically safe as well as cadmium-free.

Polyurethane is in contrast to EPP quite expensive. EPP can be molded in densities from 30 to 120 g/l and can have local density increases to enhance structural stability as necessary. EPP, as a compliant material, is inherently more comfortable than rigid material and can be modified on the upper surface, the so-called A-surface with coring or trenches to further enhance the comfort by a local stiffness reduction and weight reduction. Generally, a contoured surface that matches a human or dummy bottom form is more comfortable than the same surface without contour. EPP can be contoured. Also, the coring or trenches allow a locally softer area. Ventilation can potentially be added by providing appropriate holes, trenches or other means.

It is possible to use 30 to 40 g/l of EPP when molding an upholstery as it is provided by the present invention. At 30 to 40 g/l, EPP is lighter than the foam usually used. EPP can already be used of a density of 30 g/l while the use of PU requires generally at least a density of 50 g/l. At 30 g/l EPP weights less than PU at 50 g/l. Coring of the EPP further reduces weight. As already stated, the structural properties of EPP may obviate the need for a pan or a wire frame structure or allow minimization of metallic structural components. The ability to mold an undercut trench around the lower surface perimeter dramatically improves the trimout appearance and reduces trim time. In estimates of weight savings during the quotation process, it is possible to save about 1.5 kg over a wire frame which is currently used and about 4 kg over a steel cushion pan. The comfort can further be optimised by contouring the upper surface made by EPP to match an offset of a dummy bottom form. Attachment to a vehicle is allowed by the ability of in-molding structural components into the EPP.

Further features and embodiments of the invention will become apparent from the description and the accompanying drawings.

For purposes of clarity, the present cushion refers to an abstract example of a passenger seat cushion. However, the process and the upholstery of the present invention may operate with a wide variety of types of applications including head restraints, seat backs and armrests.

It should be understood that while the invention is described in terms of a specific seat cushion, that the invention has applications in a variety of applications such as seat backs, head restraints, and armrests. It is intended that the upholstery as used in the specification and claims be reached to cover any application unless the context requires otherwise. Therefore, the upholstery and the seat body as described in the specification and claims can also be used outside of the automotive technology in many other types of seating.

The invention is schematically illustrated in the drawings by way of an example embodiment and is explained in detail with reference to the drawings. It is understood that the description is no way limiting for the scope of the present invention and is merely an illustration of a preferred embodiment of the invention.

### BRIEF DESCRIPTION OF THE DRAWINGS

In the drawings,

FIG. 1 shows a seat body from a possible embodiment of a passenger seat according to the present invention,

FIG. 2 illustrates an enlarged partial section of a portion of a rear side of an embodiment of a passenger seat with vehicle anchorage means,

FIG. 3 shows a cross section taken along 3-3 in FIG. 1,

FIG. 4 illustrates a perspective view of a further embodiment of a passenger seat in accordance with the present invention.

### DETAILED DESCRIPTION OF THE PREFERRED EMBODIMENTS

FIG. 1 illustrates a seat body 10 of a passenger seat in accordance with the present invention. As shown in FIG. 1, the seat body 10 is molded of one single material, namely of EPP. The upper surface 11 is provided with a plurality of holes 12 to further enhance comfort and to provide weight reduction. The upper surface 11 is contoured to match an offset of a dummy bottom form.

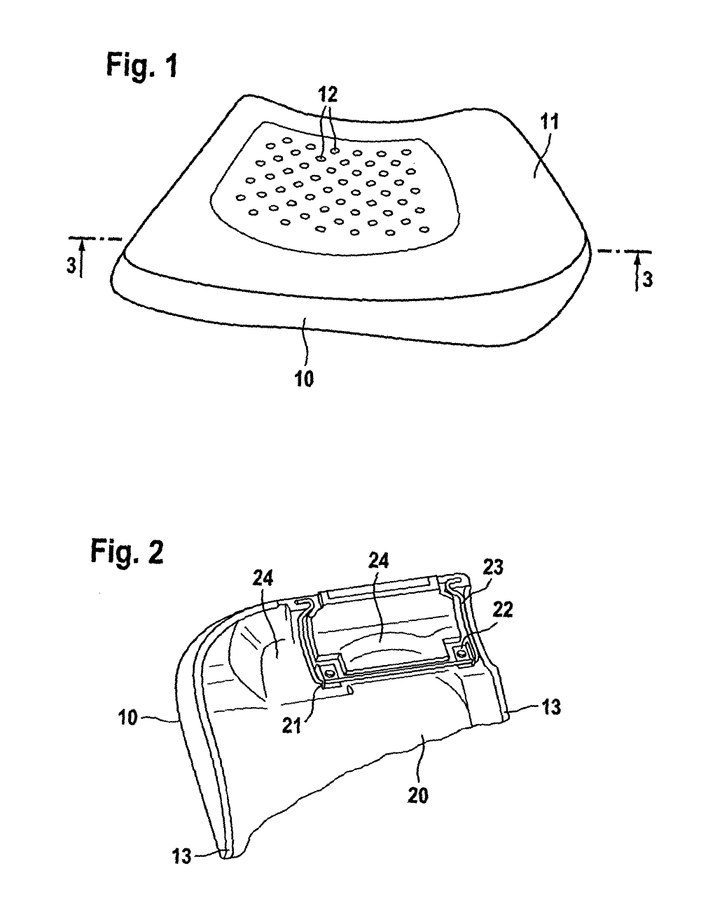

FIG. 2 shows a part of a rear side 20 of a further embodiment of a passenger seat in accordance with the present invention. The seat body 10 is made from a EPP-foam, most preferably with a density between 30 to 40 g/l. The seat body 10 may be fabricated utilizing a conventional EEP mold which has been suitably adapted to include means to retain in place vehicle anchorage means 21 in one of the molds. Specifically, an anchor portion 23 of the vehicle anchorage means 21 is connected by suitable attachment means 22 to the seat body 10. The rear side 20 comprises several recesses 24 to further enhance weight reduction. An undercut trench 13 which can be engaged by an appropriate trim cover is also shown.

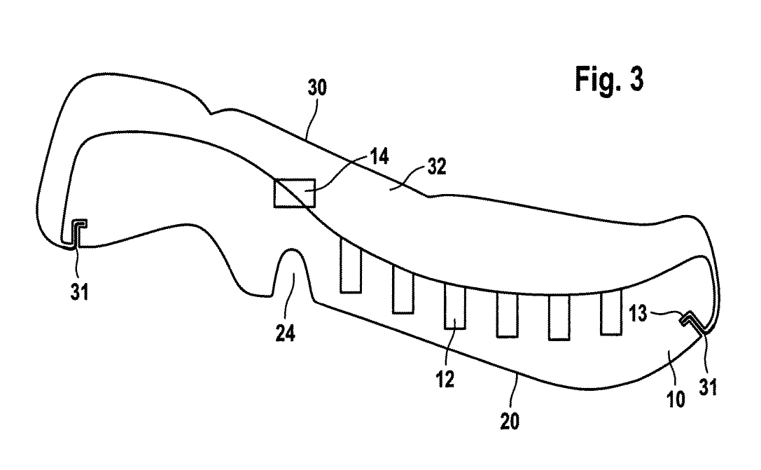

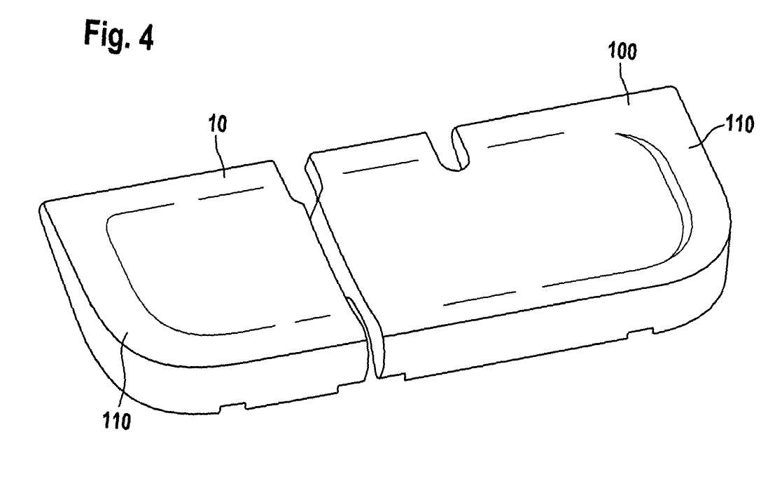

FIG. 3 illustrates a section taken along 3-3 in FIG. 1.

FIG. 3 shows a seat body 10 of a seat cushion of a vehicle seat. The seat body 10 comprises several holes 12 to enhance the comfort by reducing local stiffness and weight reduction. The seat body 10 further comprises a undercut trench 13 which can be engaged by an appropriate trim cover 30. The trim cover 30 is attached to the seat body by means of a suitable retainer engaging the undercut trench 13 molded into the seat body 10. The retainer of the trim cover 30 is formed as an extruded plastic channel 31 which is sew to the trim cover 30. An intermediate layer 32, preferably made of a soft foamed material, is located between the trim cover 30 and the seat body 10. The intermediate layer 32 can be made, for example, of PU with a density range at 30 and 60 g/l or at 42 and 50 g/l. The intermediate layer 32 can be an integral part of the trim cover 30. The seat body 10 further comprises at its lower side 20 several trenches 24 to further enhance weight reduction. On its lower side 20 there are also anchorage means, not shown, suitable to anchor the vehicle seat to the floor of the automobile vehicle. The anchorage means can be conventional mechanical attachment means, e.g. a hook and loop connection system. The seat body 10 further comprises an anti-submarine zone 14. The anti-submarine zone 14 and the seat body 10 are integrally molded as a unitary element. The anti-submarine zone 14 provides additional pelvic support to a passenger during a collision. Seat body 10 is contoured on its upper surface to match the offset of a dummy bottom form, thus, optimizing the comfort for a passenger.

FIG. 4 illustrates a perspective view of two possible embodiments 10, 100 of a seat body in accordance with the present invention. The seat body 10 abuts against the seat body 100. As shown in FIG. 4 the seat body 10 and the seat body 100 include a common flange portion 110 which serves as an edge support to minimize or prevent scalloping of the trim cover and thereby maintain a smooth appearance in the finished seat. The provisions of the seat bodies 10, 100 serve to stiffen the completed seat obviating prior art requirement for a perimeter metal frame or the like. Further, when the seat bodies 10 and 100 are molded, vehicle anchorage means are embedded into the respective lower side of seat bodies 10 and 100, respectively. The use of an embedded vehicle anchorage means obviates the prior art requirement for support rails or the like.

A trim cover and an intermediate layer of smooth foam have still to be attached to the seat bodies 10 and 100 for completing comfort quality. Polyurethane foam, having a density between 42 and 50 g/l, can be used as smooth foam for the intermediate layer.

1. An automobile vehicle passenger seat comprising:
a seat body (10) molded from EPP-foam, said EPP-foam having an average density between 30 and 60 g/l,
vehicle anchorage means (21) connected to said seat body for anchoring said seat to the automobile vehicle, and
a trim cover (30).

2. A passenger seat according to claim 1 further comprising at least one pelvic support element embedded in said seat body (10).

3. A passenger seat according to claim 2, wherein said pelvic support and said seat body (10) are integrally molded as a unitary element.

4. A passenger seat according to claim 3, wherein said seat body comprises an anti-submarine zone (14), said seat body (10) and said anti-submarine zone (14) are integrally molded as a unitary element.

5. A passenger seat according to claim 4, wherein said trim cover (30) is attached to said seat body (10) by means of a suitable retainer (31) engaging an undercut trench (13) molded into said seat body (10).

6. A passenger seat according to claim 5 wherein said retainer is formed as an extruded plastic channel (31) sew to said trim cover (30).

7. A passenger seat according to claim 6 wherein said vehicle anchorage means (21) includes an anchor portion (23) to engage a portion of the automobile vehicle and an attachment portion (22) inmolded in said seat body (10).

8. A passenger seat according to claim 7, wherein said attachment portion (22) comprises two S-shaped arms each connected to a different end of said attachment portion (22).

9. A passenger seat according to claim 8 wherein said seat body is appropriately modified with coring, cut away, and/or trenches for local stiffness and weight reduction.

10. An upholstery for use in an automobile vehicle composed of and molded from EPP-foam complex, said EPP having a density between 30 and 60 g/l.

11. An upholstery according to claim 10 wherein the upholstery is formed as a seat body (10) and connected with vehicle anchorage means (21) for anchoring said seat body (10) to the automobile vehicle.

12. An upholstery according to claim 10, wherein said upholstery is formed as a head restraint or an armrest and connected with anchorage means for anchoring said head restraint or said armrest to a seat.

13. An upholstery according to claim 12, wherein an undercut trench is molded into said upholstery intended to be engaged by fasteners of a trim cover.

14. A process for producing an upholstery for use in an automobile vehicle in a mold comprising at least a first mold half and a second mold half engageable to define a mold cavity, the process comprising the steps of:
inserting means for mechanical attachment to the vehicle, if necessary into at least one of the first mold and the second mold half;
dispensing a liquid foamable polypropylene in at least the one of the first mold half and the second mold half;
closing the first mold half and the second mold half; and
allowing the polypropylene to expand to fill substantially the mold cavity to produce a relatively low density, stable upholstery.

15. A process according to claim 14, further comprising the step of:
molding an undercut trench into the upholstery usable to attach a trim cover to the upholstery.

16. A process according to claim 15, further comprising the step of;
applying a trim cover to the upholstery.

17. A process according to claim 16, wherein the upholstery is formed as a seat body for a passenger seat.

18. A process according to claim 17 further comprising integrally molding at least one pelvic support element with the seat body.

19. A process according to claim 18, further comprising the step of modifying the upholstery with coring and trenches for local stiffness and weight reduction.
